(19) United States
(12) Patent Application Publication
(10) Pub. No.: US 2018/0210137 A1
(43) Pub. Date: Jul. 26, 2018

(54) BACKLIGHT MODULE OF LIQUID CRYSTAL DISPLAY AND MANUFACTURING METHOD THEREOF

(71) Applicant: HORTEK CRYSTAL CO., LTD., Hsinchu County (TW)

(72) Inventor: Yung Hsiang Huang, Hsinchu County (TW)

(73) Assignee: HORTEK CRYSTAL CO., LTD., Hsinchu County (TW)

(21) Appl. No.: 15/728,098

(22) Filed: Oct. 9, 2017

(30) Foreign Application Priority Data
Jan. 26, 2017 (TW) 106103256
Jan. 26, 2017 (TW) 106201628

(51) Int. Cl. F21V 8/00

(52) U.S. Cl. CPC G02B 6/0055; G02B 6/0065; G02B 6/0088; G02B 6/0043

(57) ABSTRACT

The present invention provides backlight module of a liquid crystal display and a manufacturing method thereof The backlight module includes a light guiding plate and a back plate, wherein the light guiding plate includes a bottom surface and micro-structures formed thereon, and the back plate includes a plate main body and a reflecting material. The plate main body has an inner surface being a flat plane and an outer surface, and the reflecting material is formed on the inner surface. The manufacturing method includes: providing a back plate having a plate main body with an inner surface being a flat plane and an outer surface; forming a reflecting material on the inner surface; providing a light guiding plate having a first surface, a second surface and micro-structures; and configuring the light guiding plate and the back plate to make the inner surface opposite to the second surface.

### RELATED APPLICATIONS

This application claims the priorities of Taiwan Patent Application No. 106103256, filed on Jan. 26, 2017 and Taiwan Patent Application No. 106201628, filed on Jan. 26, 2017 at the Taiwan Intellectual Property Office, the entire disclosures of which are incorporated herein by reference.

### FIELD OF THE INVENTION

The present invention relates to a backlight module of a liquid crystal display and the manufacturing method thereof, specifically a backlight module having a plate main body with a reflecting material and the manufacturing method thereof

### BACKGROUND OF THE INVENTION

The prior backlight module of a liquid crystal display mainly has a light source, a light guiding plate, an optical adhesive, a reflecting film and a back plate, wherein the reflecting film is bonded to the light guiding plate via the optical adhesive. In order to let most of the light emitted from the light source reach the liquid crystal panel, there is a plurality of mesh micro-structures formed on a surface of the light guiding plate, and the surface, which has the plurality of mesh micro-structures, of the light guiding plate is bonded to the reflecting film via the optical adhesive, wherein the patterns of the mesh micro-structures can destroy the total reflection inside the light guiding plate. The light emitted from the light source will enter into the light guiding plate through the light entrance surface of the light guiding plate, and when reaching the mesh micro-structures, the light will not be reflected but will be refracted to the reflecting film bonded to the light guiding plate. Finally, under the assistance of the reflecting film bonded to on the light guiding plate, the light reflected by the reflecting film can be guided to the liquid crystal panel via the light-emitting surface of the light guiding plate.

The prior manufacturing method of a backlight module of a liquid crystal display basically includes the following steps: providing a substrate as a light guiding plate; forming a plurality of micro-structures, which have the designed mesh patterns, on the bottom surface of the substrate using the screen printing technique; providing an optical adhesive and a reflecting film and bonding the reflecting surface of the reflecting film and the bottom surface of the light guiding plate together via the optical adhesive; providing a back plate having a rim/frame and fixing the light guiding plate into the rim/frame of the back plate; and providing a light source configured via the rim/frame and outside the light entrance surface of the light guiding plate to provide a light for the light guiding plate. After the above-mentioned steps are performed, the prior backlight module of a liquid crystal display are substantially completed.

However, in the process of manufacturing a backlight module of a liquid crystal display, it is not easy to bond the light guiding plate and the reflecting film together, so that it needs a higher threshold to complete, and thus it causes difficulty in manufacturing so as to lengthen the manufacturing time. Therefore, once the above-mentioned obstacles are overcome, the production speed of a backlight module of a liquid crystal display can be lifted and the manufacturing cost can be reduced.

In order to circumvent all the above issues, the inventors have proposed an invention “BACKLIGHT MODULE OF LIQUID CRYSTAL DISPLAY AND MANUFACTURING METHOD THEREOF.” Using the structure, the device and the manufacturing method of the present invention, it can increase the speed of manufacturing a backlight module of a liquid crystal display, reduce the manufacturing cost, and make the device thinner The summary of the present invention is described as follows.

### SUMMARY OF THE INVENTION

According to a first aspect of the present invention, a backlight module of a liquid crystal display is provided and includes a light guiding plate and a back plate. The light guiding plate includes a bottom surface and a plurality of micro-structures formed on the bottom surface, and the back plate includes a plate main body and a reflecting material. The plate main body has an inner surface being a flat plane and an outer surface, the reflecting material is formed on the inner surface, and the inner surface of the back plate is configured opposite the bottom surface of the light guiding plate.

Preferably, the backlight module further comprises an air interval layer configured between the light guiding plate and the back plate, so as to make the light guiding plate and the back plate free from contacting each other.

Preferably, the reflecting material is a copper (Cu), a silver (Ag), a gold (Au), an aluminum (Al) or a combination thereof.

Preferably, the reflecting material is formed on the inner surface at least in a coating method, an electrochemical plating method or a vapor deposition method.

Preferably, the back plate further includes a rim/frame configured around the plate main body and connected to the inner surface.

Preferably, the light guiding plate is a light guiding glass plate or a light guiding acrylic plate.

Preferably, the plate main body and the reflecting material have the same material.

Preferably, the plate main body and the reflecting material are made of the same material.

According to the second aspect of the present invention, a manufacturing method of a backlight module of a liquid crystal display is provided. The manufacturing method includes providing a back plate having a plate main body with an inner surface being a flat plane and an outer surface; forming a reflecting material on the inner surface; providing a light guiding plate having a first surface, a second surface and a plurality of micro-structures; and configuring the light guiding plate and the back plate to make the inner surface opposite to the second surface.

Preferably, the step of forming a reflecting material on the inner surface includes forming the reflecting material on the inner surface at least in a coating method, an electrochemical plating method and/or a vapor deposition method.

Preferably, the same material is used for the plate main body and the reflecting material.

The light guiding plate of the present invention does not need to be bonded to the reflecting film, and thus the assembly complexity is reduced. Accordingly, using the backlight module for a liquid crystal display and the manufacturing method of the present invention can increase the manufacturing speed, reduce the manufacturing cost, and make the liquid crystal display thinner

The present invention will be more clearly understood through the following descriptions with reference to the drawings:

### BRIEF DESCRIPTION OF THE DRAWINGS

FIGS. 1(a) and 1(b) are schematic diagrams showing the first embodiment according to the present invention.

FIG. 2 is a schematic diagram showing the second embodiment according to the present invention.

FIG. 3 is a schematic diagram showing the flow of the manufacturing method of a backlight module of a liquid crystal display according to the present invention

### DETAILED DESCRIPTION OF THE PREFERRED EMBODIMENTS

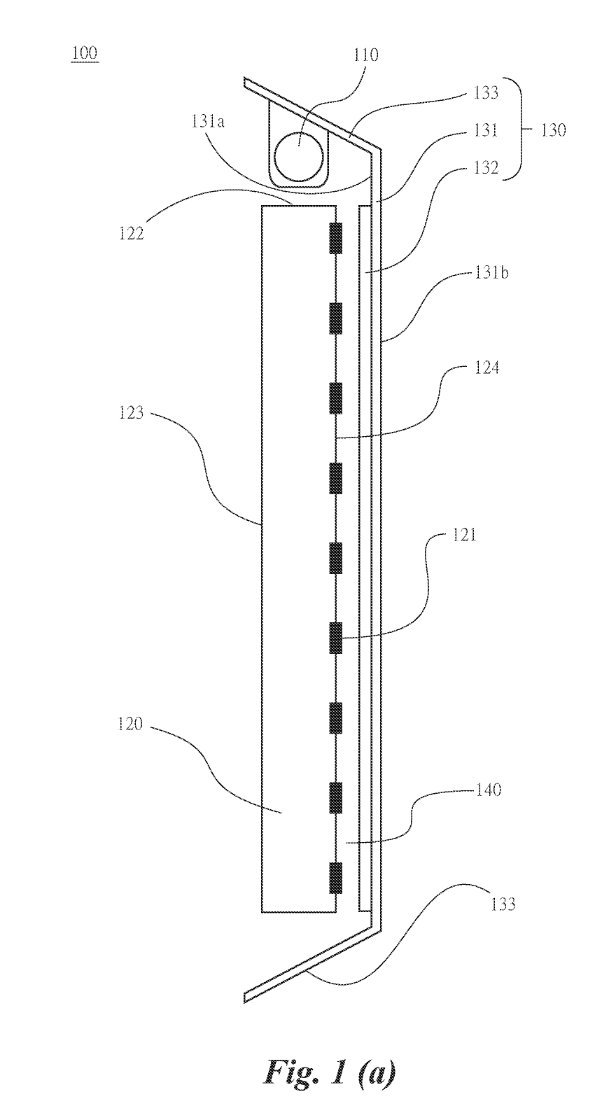

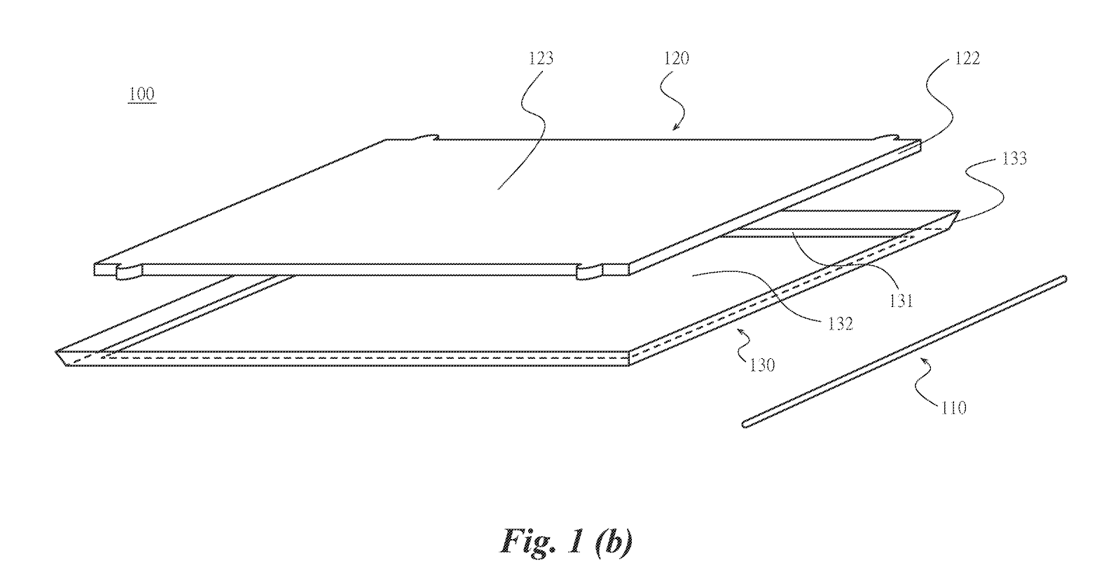

Please refer to FIGS. 1(a) and 1(b), which are schematic diagrams showing the first embodiment according to the present invention. The backlight module 100 for a liquid crystal display includes a lighting unit 110, a light guiding plate 120, a back plate 130 and an air interval layer 140, wherein the light guiding plate 120 has a plurality of micro-structures 121, a light entrance surface 122, a light-emitting surface 123 and a bottom surface 124, and the back plate 130 has a plate main body 131, a reflecting material 132 and a rim/frame 133.

The lighting unit 110 is configured to provide a light for the light guiding plate 120, and the light emitted by the lighting unit 110 reaches a liquid crystal panel (not shown) through the light guiding plate 120 and the reflecting material 132 of the back plate 130, so as to provide a planar light source for the liquid crystal display. The lighting unit 110 can be a light-emitting diode (LED), a cold cathode fluorescent lamp (CCFL) or other elements with luminescent function. Preferably, the lighting unit 110 can be a light bar.

The light guiding plate 120 is configured to guide the light emitted by the lighting unit 110, and the light emitted by the lighting unit 110 enters into the light guiding plate 120 through the light entrance surface 122 of the light guiding plate 120. One part of the light transmits out of the light guiding plate 120 through the light-emitting surface 123 because of refraction, but the problem is that the other part of the light always reflects inside the light guiding plate 120 and cannot be guided out of the light guiding plate 120 because of total internal reflection principle. In order to solve this problem, the plurality of micro-structures 121 are configured on the bottom surface 124 of the light guiding plate 120, and the plurality of micro-structures have the patterns that can destroy the total reflection within the light guiding plate 120. In other words, if the light emitted from the lighting unit 110 is reflected to any one of the plurality of micro-structures 121, the pattern on the micro-structure will make the light refract and out of the total reflection condition. Furthermore, the light guiding plate 120 of the backlight module 100 can be a light guiding acrylic plate, a light guiding glass plate or a light guiding plate made of other materials.

The back plate 130 is configured to carry or mount the lighting unit 110 and the light guiding plate 120, and to provide the reflection function. If the backlight module 100 includes other optical layers, such as a diffusion plate, a prism plate and so on, these optical layers can be mounted on the rim/frame 133 via fixing or clamping. The plate main body 131 of the back plate 130 has an inner surface 131a and an outer surface 131b, and the inner surface 131a is a flat plane. The rim/frame 133 is configured around the plate main body 131, and is configured to carry the lighting unit 110, light guiding plate 120 and/or other optical layers. The back plate 130 can be a glass back plate (including reinforced glass), a metal back plate, an acrylic back plate or other back plates that can function as a support. Moreover, the back plate 130 can function as the case of the liquid crystal display, and there are no notches or holes on the inner surface 131a, i.e. the inner surface 131a being completely plane. The rim/frame 133 can be designed to form an arc surface or an angle when connected to the inner surface 131a, and the completely planar inner surface 131a is corresponding to the light guiding plate 120 generally.

The reflecting material 132 is formed on the inner surface 131a of the plate main body 131, so as to make the backlight module 100 have reflection effect. After the light emitted by the lighting unit 110 passes through the plurality of micro-structures 121 and then refracts, the refracted light is transmitted to the reflecting material 132 of the plate main body 131. Afterward, the light is reflected to the light guiding plate 120 by the reflecting material 132, and finally the light is transmitted out of the light guiding plate 120 through the light-emitting surface 123. The reflecting material 132 can be a copper (Cu), a silver (Ag), a gold (Au), an aluminum (Al), other materials with reflection property or a combination thereof. In addition, the reflecting material 132 can be formed on the inner surface 131a in a coating method, an electrochemical plating method, a vapor deposition method or other prior methods. It is noted that the same material with reflection property can be used for the plate main body 131 and the reflecting material 132. In other words, the plate main body 131 already has light reflecting function when formed.

In the process of assembling the lighting unit 110, the light guiding plate 120 and the back plate 130, the light guiding plate 120 is fixed on the rim/frame 133 of the back plate 130 or is restricted within a certain range, and there is a distance between the light guiding plate 120 and the inner surface 131a of the plate main body 131 so as to form the air interval layer 140. Since the air interval layer 140 exists, the light guiding plate 120 and the back plate 130 are not bonded to each other. Furthermore, besides the way of fixing the light guiding plate 120 on the rim/frame 133, the clamping way can also be used to prevent the light guiding plate 120 from being moved arbitrarily in the backlight module 100.

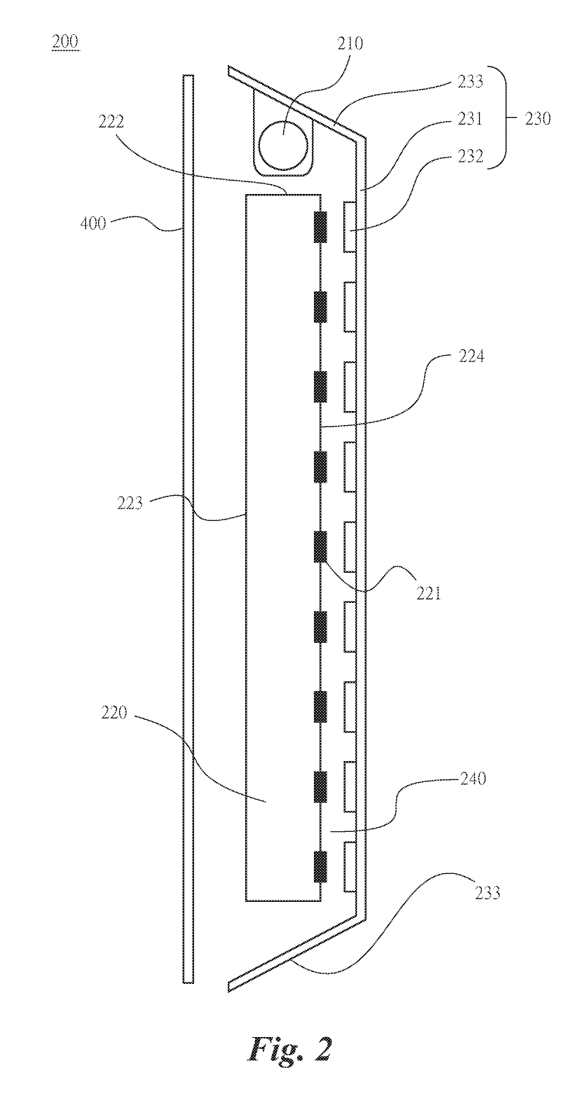

Please refer to FIG. 2, which is a schematic diagram showing the second embodiment according to the present invention. The backlight module 200 for a liquid crystal display includes a lighting unit 210, a light guiding plate 220, a back plate 230 and an air interval layer 240, wherein the light guiding plate 220 has a plurality of micro-structures 221, a light entrance surface 222, a light-emitting surface 223 and a bottom surface 224, and the back plate 230 has a plate main body 231, a reflecting material 232 and a frame 233. The back plate 230 is configured to mount/bear the lighting unit 210 and the light guiding plate 220, and the plurality of micro-structures 221 are configured on the bottom surface 224 of the light guiding plate 220.

In the second embodiment of the present invention, the reflecting material 232 at least partially covers the inner surface of the plate main body 231 in a coating method, an electrochemical plating method, a vapor deposition method or other prior methods, so as to form a plurality of reflecting areas. The corresponding locations and the shapes of the plurality of reflecting areas can be designed on demand. Since the reflecting material 232 does not totally cover the inner surface of the plate main body 231, the consumption of the reflecting material 232 is reduced to control the cost, especially for expensive reflecting materials.

In the second embodiment of the present invention, a liquid crystal panel 400 is configured outside the light-emitting surface 223 of the light guiding plate 220 of the backlight module 200, and the light emitted by the lighting unit 210 enters into the light guiding plate 220 through the light entrance surface 222 of the light guiding plate 220. One part of the light reaches the liquid crystal panel 400 under reflection and refraction and through the light-emitting surface 223. The other part under the total reflection condition inside the light guiding plate 220 is transmitted to the plurality of micro-structures 221, refracted out of the light guiding plate 220 and then transmitted to the reflecting material 232 on the inner surface of the plate main body 231. Afterwards, the light is reflected by the reflecting material 232 to enter the light guiding plate 220, and then guided out of the light-emitting surface 223 to reach the liquid crystal panel 400.

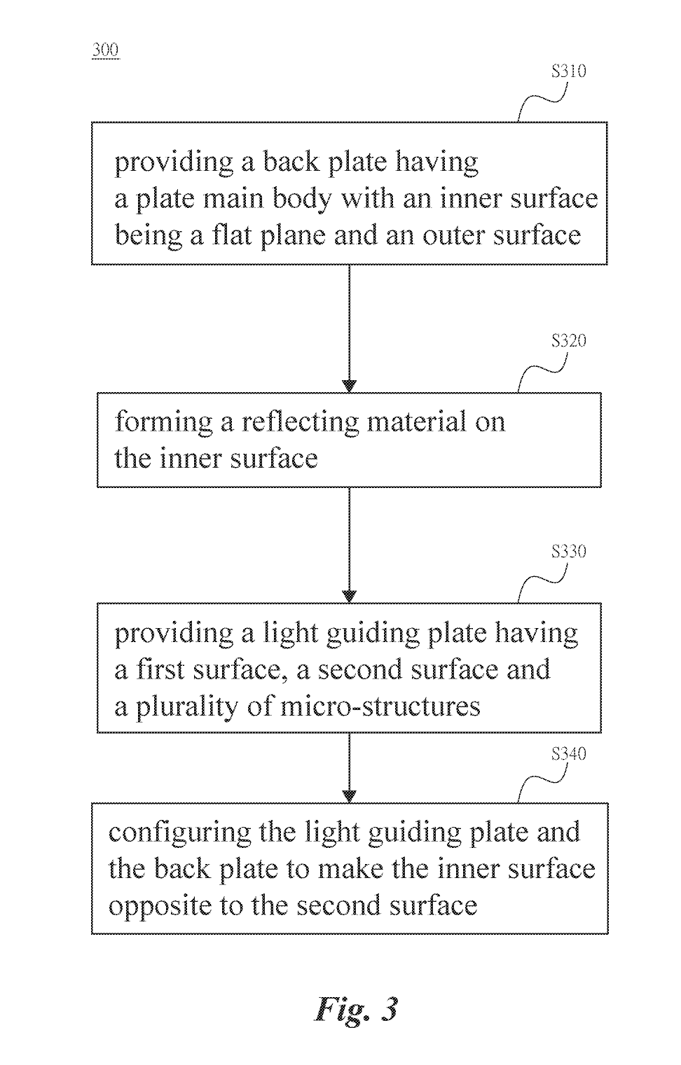

Please refer to FIG. 3 which shows the flow of the manufacturing method of a backlight module of a liquid crystal display according to the present invention. The manufacturing method 300 includes the following steps: providing a back plate having a plate main body with an inner surface being a flat plane and an outer surface (S310); forming a reflecting material on the inner surface (S320); providing a light guiding plate having a first surface, a second surface and a plurality of micro-structures (S330); and configuring the light guiding plate and the back plate to make the inner surface opposite to the second surface (S340). The Steps in the manufacturing method 300 are described as follows.

In the manufacturing method 300, the back plate provided in the step S310 can be a glass back plate, a metal back plate, an acrylic back plate or other back plates that can function as a support. There will be no notches or holes on the inner surface of the plate main body, and thus the inner surface is completely plane. In addition, the back plate can further include a frame, and the frame is connected to the periphery of the plate main body, so as to form the back plate.

The step S320 in the manufacturing method 300 is to use a coating method, an electrochemical plating method, a vapor deposition method or other prior methods to make the reflecting material formed on the inner surface, and the reflecting material is at least formed on a part of the inner surface. The reflecting material can be a copper (Cu), a silver (Ag), a gold (Au), an aluminum (Al), other materials with reflection property or a combination thereof After performing the step S302, the plate main body will have reflection function, and can reflect the light, which is refracted to the back plate, to the light guiding plate. It is noted that the same material with reflection property can be used for the plate main body and the reflecting material.

The light guiding plate provided in the step S330 of the manufacturing method 300 can be a light guiding acrylic plate, a light guiding glass plate or a light guiding plate made of other materials, and the plurality of micro-structures are formed on the second surface. The patterns of the plurality of micro-structures can destroy the total reflection in the light guiding plate, and the light refracted by the micro-structures is transmitted to the reflecting material of the plate main body.

The step S340 in the manufacturing method 300 is to assemble the light guiding plate and the back plate through configuring the second surface of the light guiding plate opposite to the inner surface of the back plate, so as to form the backlight module of a liquid crystal display. In other words, the second surface having the plurality of micro-structures of the light guiding plate faces the inner face of the back plate.

The invention need not be limited to the disclosed embodiments and the wording/terms, and it is intended to cover various modifications and similar arrangements included within the spirit of the present invention and the scope of the appended claims

What is claimed is:

1. A backlight module of a liquid crystal display, comprising:
a light guiding plate including a bottom surface and a plurality of micro-structures formed thereon; and
a back plate including a plate main body and a reflecting material, wherein the plate main body has an inner surface being a flat plane and an outer surface, the reflecting material is formed on the inner surface, and the inner surface of the back plate is configured opposite the bottom surface of the light guiding plate.

2. The backlight module as claimed in claim 1, further comprising an air interval layer configured between the light guiding plate and the back plate, so as to make the light guiding plate and the back plate free from contacting each other, wherein the reflecting material at least partially covers the inner surface of the plate main body to form a plurality of reflecting areas.

3. The backlight module as claimed in claim 1, wherein the reflecting material is one selected from the group consisting of a copper (Cu), a silver (Ag), a gold (Au), an aluminum (Al) and a combination thereof

4. The backlight module as claimed in claim 1, wherein the reflecting material is formed on the inner surface at least in one of a coating method, an electrochemical plating method and a vapor deposition method.

5. The backlight module as claimed in claim 1, wherein the back plate further includes a frame configured around the plate main body and connected to the inner surface.

6. The backlight module as claimed in claim 1, wherein the light guiding plate is one of a light guiding glass plate and a light guiding acrylic plate.

7. The backlight module as claimed in claim 1, wherein the plate main body and the reflecting material have a same material.

8. A manufacturing method of a backlight module of a liquid crystal display, comprising:
providing a back plate having a plate main body with an inner surface being a flat plane and an outer surface;
forming a reflecting material on the inner surface;
providing a light guiding plate having a first surface, a second surface and a plurality of micro-structures; and
configuring the light guiding plate and the back plate to make the inner surface opposite to the second surface.

9. The manufacturing method as claimed in claim 8, wherein the step of forming a reflecting material on the inner surface includes forming the reflecting material to at least partially cover the inner surface to form a plurality of reflecting areas at least in one of a coating method, an electrochemical plating method and a vapor deposition method.

10. The manufacturing method as claimed in claim 8, wherein a same material is used for the plate main body and the reflecting material.
